(19) United States
(12) Patent Application Publication
(10) Pub. No.: US 2010/0158260 A1
(43) Pub. Date: Jun. 24, 2010

(54) DYNAMIC AUDIO MODE SWITCHING

(75) Inventors: David Huddart, Westbury-on-Trym (GB); Andrew Knowles, Southampton (GB); Scott Walsh, Foxham (GB); Peter K. Reid, Marlborough (GB)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/343,924

(22) Filed: Dec. 24, 2008

(51) Int. Cl. H04R 29/00

(52) U.S. Cl. 381/56

(57) ABSTRACT

In one embodiment, a method and apparatus for processing an audio signal are provided. In one example of the invention, an audio signal is received. The audio signal is classified as a high quality signal or a low quality signal based upon a determination of the bandwidth, signal source, and/or signal type of the audio signal. The audio signal is further processed responsive to whether the audio signal is classified as a high quality signal or a low quality signal.

### BACKGROUND

Headsets are used for various types of audio, including but not limited to standard telephony, which has an audio bandwidth with an upper frequency limit lower than about 4 kHz (narrowband), and wideband audio (e.g., from a personal computer or VoIP), which has an audio bandwidth with an upper frequency limit greater than about 6 kHz. A mechanical switch has been previously activated by a user to switch between the modes of audio.

Furthermore, it is common practice for communications workers in offices, for example, to listen to music when not engaged on a telephone call. In the prior art, this has been achieved by using a headset and separate headphones. More recently, headset amplifiers are capable of being connected to either a telecommunications device or an external sound source such as a MP3/CD player or PC, allowing the user to engage in speech communications or listen to music with a single headset and headset amplifier.

Modem headsets can now support wideband audio as well as narrowband audio, but support of wideband audio disadvantageously requires greater use of the radio spectrum, which can result in more interference generation while lowering user density and increasing power requirements for a headset (or reduced battery life for the wireless type of headset). For example, the Digital Enhanced Cordless Telecommunications (DECT) radio frequency (RF) protocol uses approximately 120 individual RF time slots, which can each carry one “packet” of low quality audio (3.4 Khz). The transmission of higher quality audio (>6 KHz) requires the use of two time slots. The use of two time slots uses more RF bandwidth and therefore increases the amount of RF interference within a given location and also lowers user density.

Thus, improved systems, apparatus, and methods capable of efficiently and automatically processing both narrowband and wideband audio signals are needed.

### DESCRIPTION OF THE DRAWINGS

The features and advantages of the apparatus and method of the present invention will be apparent from the following description in which:

FIG. 1 is a flowchart illustrating the operation of the invention in one example.

FIG. 2 illustrates an example of the hardware architecture in one example of the invention.

FIG. 3 illustrates a headset amplifier application in one example of the invention.

FIG. 4 is flowchart illustrating the operation of the invention in another example.

FIG. 5 is flowchart illustrating the operation of the invention in another example.

### DETAILED DESCRIPTION

The present invention provides a solution to the needs described above through an inventive method and apparatus for providing dynamic audio mode switching between narrowband and wideband audio signals thereby reducing interference and power requirements for audio signal output (e.g., increasing battery life in wireless apparatus) without reducing audio quality.

Other embodiments of the present invention will become apparent to those skilled in the art from the following detailed description, wherein is shown and described only the embodiments of the invention by way of illustration contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive. The data structures and code described in this detailed description are typically stored on a computer readable storage medium, which may be any device or medium that can store code and/or data for use by a computer system. Furthermore, although software code or components are described in certain instances, those skilled in the art will recognize that such may be equivalently replaced by firmware and hardware components. For purpose of clarity, details relating to technical material that is known in the technical fields related to the invention have not been described in detail so as not to unnecessarily obscure the present invention.

The present invention provides a method and apparatus for processing an audio signal. The method and apparatus may be used in systems such as those that play sound via an audio device located close to the listener's ear or via a loudspeaker or other transducer located distant from the listener.

In one example of the invention, an audio signal is received, and the bandwidth requirements of an associated RF link is determined. The bandwidth of the RF signal is limited accordingly (e.g., one or two time slots are provided based upon a low (narrow) or high (wide) quality bandwidth determination), thus reducing RF interference and providing more RF bandwidth for other users, effectively increasing the number of potential users within a given area. In the case of the DECT protocol, for example, 120 low audio quality users or 60 high audio quality users, or any combination between the two, is made available through the present invention.

The audio signal is further processed responsive to whether the audio signal has a narrow bandwidth or a wide bandwidth, such as through a change in codec or bit rate provided for the signal. Thresholds for narrow and wide bandwidths may be set based upon empirical tests for telephone-grade audio, music, digital audio from a personal computer, and so on. For example, a narrow bandwidth may be set to have an upper frequency limit lower than about 4 kHz and a wide bandwidth may be set to have an upper frequency limit greater than about 6 kHz. If the audio signal is classified to have a narrow bandwidth, the processing includes a low quality mode signal processing in which the communications channel provides a narrow bandwidth for the audio signal. If the audio signal is classified to have a wide bandwidth, the processing includes a high quality mode signal processing in which the communications channel is instructed to provide a wide bandwidth for the audio signal. In one application of the invention, the determination and signal processing occurs within a headset amplifier. In this application, the headset amplifier and associated headset may be used with any electronic device where audio, such as speech or music, may be output. In a further application of the invention, the determination and signal processing is performed within a host personal computer, such as in voice over Internet Protocol (VoIP) applications where the headset is directly connected to the personal computer. In yet a further application of the invention, the determination and signal processing is performed within a headset.

In another example of the invention, an audio signal is received, and the source of the audio signal is determined. The audio signal is further processed responsive to the audio signal source determination, such as whether the audio signal source is a telephone or not. If the audio signal source is determined to be a telephone, the processing includes a low quality mode signal processing. If the audio signal source is determined to not be a telephone, the processing includes a high quality mode signal processing.

In yet another example of the invention, an audio signal is received, and the type of audio signal is determined, such as music/speech or music/non-music. The audio signal is further processed responsive to the audio signal type determination. For example, if the audio signal type is determined to be non-music, the processing includes a low quality mode signal processing. If the audio signal type is determined to be music, the processing includes a high quality mode signal processing, such as providing a stereo output.

The present invention permits listening to both narrowband and wideband audio while reducing the potential for interference (based upon reduced spectrum usage) and reducing power usage for wireless systems (increasing battery life). The signal processing performed on the audio is automatically selected invisibly to the user based on whether the audio signal is determined to be narrowband/wideband, from a particular source (or not), and/or of a particular type (or not). A decision to provide a particular signal processing path or audio mode is based upon at least one audio signal characteristic or a combination of audio signal characteristics to provide an audio mode switching algorithm. Advantageously, when a high quality mode is determined to be needed, such as for VoIP or a PC call, a higher quality mode and more bandwidth are provided, but when a higher quality mode is determined to be not necessary, such as for a standard telephony call, a lower quality mode and lower bandwidth are provided, thereby reducing interference and power requirements.

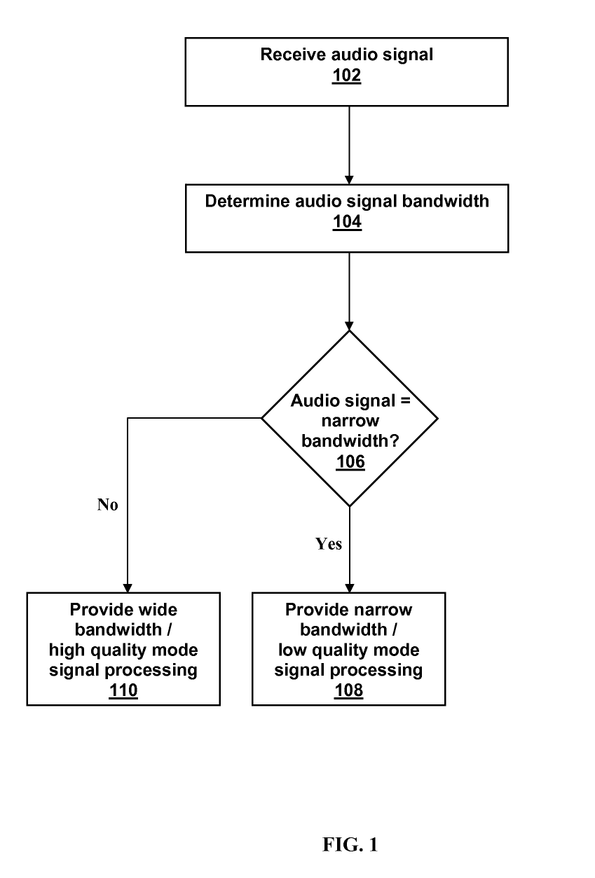

FIG. 1 is a flow chart illustrating the operation of the invention in one embodiment. At block 102, an audio signal is received for processing. At block 104, the audio signal bandwidth is determined. At block 106, the audio signal is examined to determine whether it is a narrowband signal or a wideband signal. If yes, narrow bandwidth/low quality mode signal processing is performed on the signal at block 108, and the audio signal is output to the user. If no, wide bandwidth/high quality mode signal processing is performed on the signal at block 110, and the audio signal is output to the user. The received audio signal may be continuously monitored, with the default setting that the audio signal is a narrowband signal in one example. The default setting may be a wideband signal in other examples. Additional signal processing may be provided, such as codec and/or bit rate switching. In the case of the DECT protocol, one or two time slots are provided, based upon a determination of a narrow bandwidth or wide bandwidth requirement, respectively.

The determination of the audio signal bandwidth at block 104 may be performed using a variety of signal processing techniques. In one example, spectral analysis is used. A fast Fourier transform DSP algorithm analyzes the audio signal received by the amplifier in different frequency bands. For example, the signal may be analyzed in half octave frequency bands and the signal bandwidth can be determined

Once the bandwidth determination is made, the switch from a narrow bandwidth classification to a wide bandwidth classification and vice-versa occurs at a predetermined threshold. In one example, the assessment of bandwidth is a continuous process and a threshold algorithm can be implemented to provide dynamic audio mode switching. The threshold has a time and hysteresis factor built in that prevents undesirable hunting between the two states. The switching characteristic may have a soft transition so as not to be noticeable to the user except in that the benefits of this invention results in good music fidelity, reduced interference, and energy efficiency. In one example, a narrow bandwidth may be set to have an upper frequency limit lower than about 4 kHz and a wide bandwidth may be set to have an upper frequency limit greater than about 6 kHz.

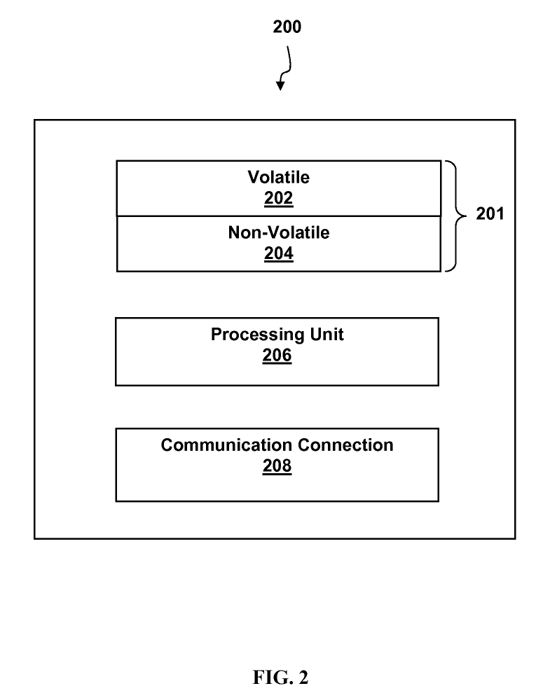

Referring now to FIG. 2, one example system 200 for implementing the processes set forth in FIG. 1 is shown. The system 200 typically includes at least one processing unit 206 and memory 201. Processing unit 206 interfaces with memory 201 and communication connection 208 to receive and send audio to and from other devices. Processing unit 206 processes information and instructions used by system 200 (e.g., to classify an audio signal as a high quality signal or a low quality signal based upon at least one characteristic of the audio signal, and to process the audio signal responsive to whether the audio signal is classified as a high quality signal or a low quality signal). Memory 201 is any type of memory that can be used to store code and data for processing unit 206, and in one example may be used to store signal processing algorithms, signal classification/determination algorithms, threshold algorithms, and the like. Depending on the exact configuration and type of device system 200 which is implemented, memory 201 may include volatile memory 202 (such as RAM), non-volatile memory 204 (such as ROM, flash memory, etc.) or some combination of the two. By way of example, and not limitation, the communication connection 208 may include wired media such as a direct-wired connection, and wireless media such as an RF link.

The device on which system 200 is implemented may have a variety of features and functionality. The implementation device may utilize several forms of computer storage media. Depending on the particular device, the computer storage media may include volatile and nonvolatile, removable and non-removable media implemented in any method or technology for storage of information such as computer readable instructions, data structures, program modules or other data. Memory 201 may be incorporated or integrated with the computer storage media of the implementation device. Computer storage media includes, but is not limited to, RAM, ROM, EEPROM, flash memory or other memory technology. Where the implementation device is a personal computer, the computer storage media includes CD-ROM, digital versatile disks (DVD) or other optical storage, magnetic cassettes, magnetic tape, magnetic disk storage or other magnetic storage devices, or any other medium which can be used to store the desired information and which can accessed by the implementation device on which system 200 is implemented.

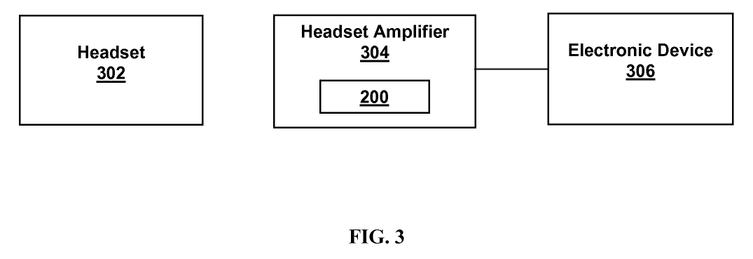

For example, referring to FIG. 3, system 200 may be implemented on a headset amplifier 304. By implementing system 200 at a headset amplifier 304, system 200 is independent of the electronic device to which it is attached and can therefore be used with a variety of electronic devices. The headset amplifier 304 may have multiple inputs to accommodate multiple devices simultaneously. Processing power at headset amplifier 304 may advantageously be higher than other components. In a further example, system 200 may be implemented on a desktop or laptop personal computer, mobile handset, personal digital assistant, headset, or sound card. Although described independently here, processing unit 206 and memory 201 typically already reside on the device to perform other functions associated with the device. Thus, implementation of processing set forth in FIG. 1 may not require additional hardware resources.

In one application, a headset 302 is couplable to a headset amplifier 304 which, in turn, is connected to an electronic device 306. For example, the electronic device 306 may be a telephone, digital music player, PDA, or an integrated device combining functionality of two or more of such devices. The headset 302 includes at least one speaker and a microphone and may be wired or wireless.

The headset amplifier 304 is generally used to amplify signals to or from electronic device 306. In one application, the headset amplifier 304 receives the audio signal from electronic device 306, determines an audio mode for the signal based upon at least one audio signal characteristic, and provides a power output to drive the speaker of the headset 302. The headset amplifier 304 may provide power for the headset microphone, receives the audio signal from the microphone, and modifies the audio signal from the microphone. Typically, an electret microphone is used, which requires that headset amplifier 304 supply DC power of a few volts at between 15 and several hundred microamps to a wired headset 302.

In the present example, headset amplifier 304 includes system 200 for performing digital signal processing on the audio signal in addition to amplification. The headset amplifier 304 may provide automatic and dynamic audio mode switching dependent on at least one audio signal characteristic, such as audio signal bandwidth, source, and/or type in order to provide higher audio quality, reduced interference, and/or increased energy efficiency.

Headset amplifier 304 may receive power from a variety of sources. For example, it may draw current from electronic device 306. Headset amplifier 304 may also be powered with a battery or from power derived from the USB port of a PC or from an AC wall outlet using a DC power supply. Advantageously, the present invention allows for greater power efficiency in the headset amplifier.

Although a headset has been mentioned in this embodiment, the systems and methods described herein may be utilized for various audio devices located close to the listener's ear such as a headset, handset, mobile phone, headphone, or earphone, as well as audio devices located at a distance to the listener's ear such as loudspeakers or other transducers located distant from the listener. For the case in which system 200 is implemented within headset 302 or another audio device located close to the listener's ear and requiring a battery (such as for a wireless headset), battery life is advantageously increased and interference is advantageously decreased with the automatic and dynamic audio mode switching of the present invention.

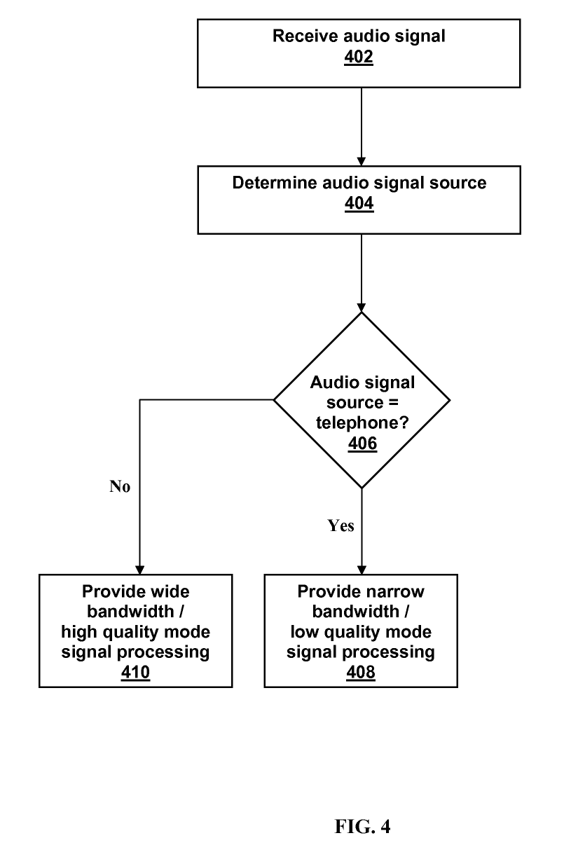

FIG. 4 is a flow chart illustrating the operation of the invention in another embodiment. At block 402, an audio signal is received for processing (e.g., by communication connection 208 of FIG. 2). At block 404, the source of the incoming audio signal is classified, such as from a telephone, the Internet, or a personal computer (e.g., by processing unit 206 of FIG. 2). It can be assumed that if the audio signal source is from a standard telephone, the audio is narrowband and narrow bandwidth/low quality mode signal processing may be provided. However, if the audio signal source is not from a telephone, but from a PC for example, it can be assumed the audio is wideband and wide bandwidth/high quality mode signal processing may be provided. At block 406, the audio signal is examined to determine whether the audio signal source is a telephone (e.g., by processing unit 206 of FIG. 2). If yes, narrow bandwidth/low-quality mode signal processing is performed on the audio signal at block 408, and the audio signal is output to the user. If no, wide bandwidth, high-quality mode signal processing of the audio signal is performed at block 410, and the audio signal is output to the user. The received audio signal may be continuously monitored, with the default setting that the audio signal source is a telephone in one example. The default setting may be a non-telephone audio signal source in other examples. Various audio signal sources may be determined and classified for high quality or low quality mode processing. Additional signal processing may also be provided similar to those described above.

The determination of the audio signal source may be performed using a variety of signal processing techniques. In one example, routing labels, point codes, network identifiers, ISDN User Part or its variants, and the like, may be detected and read to determine the signal source.

Once the audio source determination is made, the switch from a high quality mode to a low quality mode and vice-versa may occur with a time and hysteresis factor built in that prevents undesirable hunting between the two states. The switching characteristic may have a soft transition so as not to be noticeable to the user except in that the benefits of this invention results in good music fidelity, reduced interference, and energy efficiency. In one example, the assessment of the audio signal source is a continuous process to provide dynamic audio mode switching.

This embodiment may be implemented in a similar system and apparatus (e.g., in a PC, a headset amplifier, and/or a headset) as that described above with respect to FIGS. 2 and 3, and repeated description of common elements are omitted.

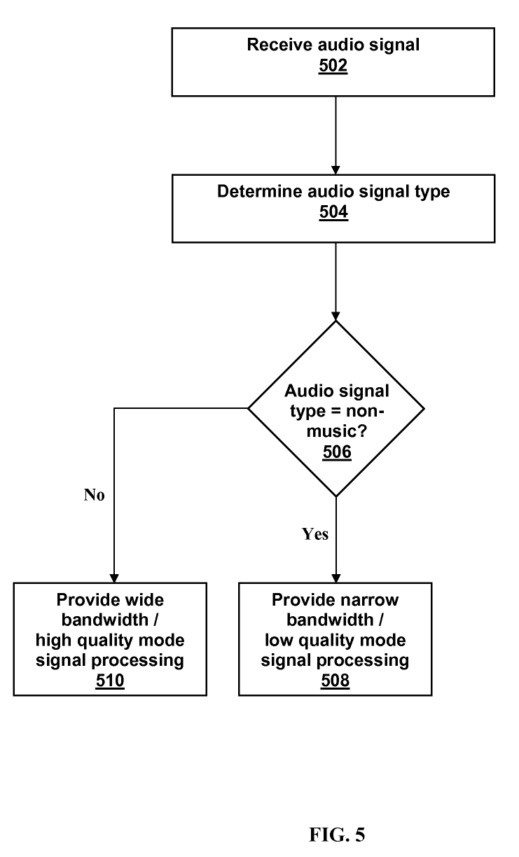

FIG. 5 is a flow chart illustrating the operation of the invention in yet another embodiment. At block 502, an audio signal is received for processing (e.g., by communication connection 208 of FIG. 2). At block 504, the audio signal type is classified, such as a music signal or a non-music signal (e.g., speech) (e.g., by processing unit 206 of FIG. 2). At block 506, the audio signal is examined to determine whether it is a music signal or a non-music signal (e.g., by processing unit 206 of FIG. 2). If yes, narrow bandwidth/low-quality mode signal processing is performed on the non-music signal at block 508, and the audio signal is output to the user. If no, wide bandwidth / high-quality mode signal processing of the audio signal is performed at block 510, such as a high quality “stereo audio” mode, and the audio signal is output to the user. The received audio signal may be continuously monitored, with the default setting that the audio signal is a non-music signal in one example. The default setting may be a music signal in other examples. Additional signal processing may be provided similar to those described above.

The classification of the audio signal type as a non-music signal (e.g., a speech signal) or a music signal at block 504 may be performed using a variety of signal processing techniques. In one example, spectral analysis is used. A fast Fourier transform DSP algorithm analyzes the audio signal received by the amplifier in different frequency bands. For example, the signal may be analyzed in half octave frequency bands. From this analysis, the spectral power density of differing bands is compared. A music signal will tend to have similar energy in adjacent bands (averaged over a short period) and significant energy above 3000 Hz and below 300 Hz. Conversely, the spectral characteristics of a non-music signal (e.g., a speech signal) tend to demonstrate high peaks in single sub-octave bands relative to adjacent bands and most energy is in the frequency range between 300 and 3000 Hz. An algorithm based on this technique provides a continuous probability (0 to 100%) of the current signal being music.

Another classification method is described by Saunders in “Real-Time Discrimination of Broadcast Speech/Music”, IEEE 0-7803-3192-3/96, which is hereby incorporated by reference. This classification method is based on the analysis of the zero crossings rate of the audio signal. The rate and changes in rate of zero crossings are used to differentiate music signals. This method uses less processor power and memory than traditional fast-Fourier transform techniques. Improvements in recognition speed to Saunders are proposed by El-Maleh et al in “Music Speech Discrimination for Multimedia Applications” in Proceedings of IEEE Conference Acoustics, Speech, Signal Processing (June 2000), which is hereby incorporated by reference.

Additional classification techniques include Gaussian mixture model, Gaussian model classification and nearest-neighbor classification. These techniques use statistical analyses of underlying features of the audio signal, either in a long or short period of measurement time, resulting in separate long-term and short-term features.

Once the determination is made, the switch from a non-music classification to a music classification and vice-versa occurs at a predetermined threshold. The assessment of non-music versus music is a continuous process. For any particular example implementation, numerous empirical tests using music and speech measuring the “music probability” in the range 0 to 100% may be performed. The distribution of speech and music can then be overlayed and one would expect to see no, or a very small overlap in the distribution curves. From this data, a threshold algorithm can be derived. The threshold has a time and hysteresis factor built in that prevents undesirable hunting between the two states. The switching characteristic may have a soft transition so as not to be noticeable to the user except in that the benefits of this invention results in good music fidelity, reduced interference, and energy efficiency. This threshold can be linked to the probability that the signal being processed is non-music (the higher the probability it is non-music, the lower the delta threshold).

This embodiment may also be implemented in a similar system and apparatus (e.g., in a PC, a headset amplifier, and/or a headset) as that described above with respect to FIGS. 2 and 3, and repeated description of common elements are omitted.

While embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A method for processing an audio signal, the method comprising:
receiving an audio signal;
classifying the audio signal as a high quality signal or a low quality signal based upon at least one characteristic of the audio signal; and
processing the audio signal responsive to whether the audio signal is classified as a high quality signal or a low quality signal.

2. The method of claim 1, wherein the audio signal is received at one of a headset, a headset amplifier, and a personal computer.

3. The method of claim 1, wherein the at least one characteristic of the audio signal includes an audio signal bandwidth.

4. The method of claim 1, wherein the at least one characteristic of the audio signal includes an audio signal source.

5. The method of claim 1, wherein the at least one characteristic of the audio signal includes an audio signal type.

6. The method of claim 1, wherein classifying the audio signal as a high quality signal or a low quality signal comprises analyzing the audio signal in different frequency bands and comparing a spectral power density of different bands.

7. The method of claim 1, wherein classifying the audio signal as a high quality signal or a low quality signal comprises analyzing a zero crossings rate of the audio signal.

8. The method of claim 1, further comprising switching between a high quality signal classification and a low quality signal classification at a predetermined threshold having a built in hysteresis factor.

9. A computer readable storage medium storing instructions that when executed by a computer cause the computer to perform a method for processing an audio signal, comprising:
receiving an audio signal;
classifying the audio signal as a high quality signal or a low quality signal based upon at least one characteristic of the audio signal; and
processing the audio signal responsive to whether the audio signal is classified as a high quality signal or a low quality signal.

10. The computer readable storage medium of claim 9, wherein the audio signal is received at one of a headset, a headset amplifier, and a personal computer.

11. The computer readable storage medium of claim 9, wherein the at least one characteristic of the audio signal is selected from the group consisting of an audio signal bandwidth, an audio signal source, and an audio signal type.

12. The computer readable storage medium of claim 9, wherein classifying the audio signal as a high quality signal or a low quality signal comprises analyzing the audio signal in different frequency bands and comparing a spectral power density of different bands.

13. The computer readable storage medium of claim 9, wherein classifying the audio signal as a high quality signal or a low quality signal comprises analyzing a zero crossings rate of the audio signal.

14. The computer readable storage medium of claim 9, wherein the method further comprises switching between a high quality signal classification and a low quality signal classification at a predetermined threshold having a built in hysteresis factor.

15. An apparatus for processing an audio signal comprising:
a receiving mechanism for receiving an audio signal;
a classifying mechanism for classifying the audio signal as a high quality signal or a low quality signal based upon at least one characteristic of the audio signal; and
a processing mechanism for processing the audio signal responsive to whether the audio signal is classified as a high quality signal or a low quality signal.

16. The apparatus of claim 15, wherein the audio signal is received at one of a headset, a headset amplifier, and a personal computer.

17. The apparatus of claim 15, wherein the at least one characteristic of the audio signal is selected from the group consisting of an audio signal bandwidth, an audio signal source, and an audio signal type.

18. The apparatus of claim 15, wherein the classifying mechanism is configured to analyze the audio signal in different frequency bands and compare a spectral power density of different bands.

19. The apparatus of claim 15, wherein the classifying mechanism is configured to analyze a zero crossings rate of the audio signal.

20. The apparatus of claim 15, wherein the classifying mechanism is configured to switch between a high quality signal classification and a low quality signal classification at a predetermined threshold having a built in hysteresis factor.
